(19) United States
(12) Patent Application Publication
(10) Pub. No.: US 2004/0085770 A1
(43) Pub. Date: May 6, 2004

(54) Luminaire

(76) Inventors: Thomas P. Tyler, Wallkill, NY (US); Jonathan A. Connell, Hawley, PA (US)

Correspondence Address: LACKENBACH SIEGEL, One Chase Road, Scarsdale, NY, 10583, US

(21) Appl. No.: 10/286,727

(22) Filed: Nov. 1, 2002

(51) Int. Cl. F21V 7/00

(52) U.S. Cl. 362/297; 362/347; 362/346; 362/348

(57) ABSTRACT

A luminaire for providing wide-angle illumination has a housing with an open side and an arcuate reflector with a reflecting surface that defines a plane of substantial symmetry. This reflecting surface is mounted within the housing and arranged to orient the reflecting surface towards the open side and has first and second reflector portions that are substantially mirror images of each other in relation to the plane of symmetry. The reflecting portions define a focal axis that is normal to said plane of symmetry and formed of a plurality of a substantially elongate reflecting facet surfaces or a series of reflector strips each of which is substantially parallel to the focal axis, the arcuate reflector having asymmetrical cycloidal cross sections in planes substantially normal to the focal axis, and the reflector portions forming an indentation or cusp in the direction of the light source at the point where they meet along the plane of symmetry at least in the region of the focal axis. The luminaire additionally has a light source mounted centrally along the focal axis, which provides both a direct light output and a reflected light output through the open side, forming a substantially uniform beam for a predetermined distance in a direction substantially parallel to the plane of symmetry.

### BACKGROUND OF THE INVENTION

1. Field of the Invention

This invention generally relates to lighting fixtures, and, more specifically, to a luminaire for providing wide-angle illumination on a surface.

2. Description of the Prior Art

Cyclorama (CYC) lights have been widely used for both stage and architectural applications. Cyc lights are used to form, for example, the background for a theatrical-type setting. Cyc lights are luminaires that are typically mounted at the top and/or bottom of a cyclorama in order to light it in a smooth, uniform manner. These are typically used to provide a certain mood or simulate a background such as the sky or suggest limitless space. Traditionally cycloramas were horizontally curved, but may also be flat or vertically curve as well.

Because cyc lights are designed to maintain a substantially uniform illumination of brightness over a surface that is increasingly more distant from it, special reflectors are used that are asymmetrically arranged in relation to a focal axis at which a light source is placed. While such lamps have generally been acceptable, it has been found that, depending on the reflector and the light source used, there are still significant variations in the brightness on the illuminated surface. This is particularly true when the lamp or bulb that is used along the focal axis is not a true point-source. With the advent of more efficient bulbs the uniformity of the illumination has in some instances improved, although there are still bright spots or significant light-dark boundaries and reduced shadow effects. Examples of cyc-type lighting fixtures are disclosed, for example, in the following U.S. Pat. Nos. 4,799,136; 4,229,779 and blank. Other patents that disclose lighting fixtures for providing wide areas of illumination including the following U.S. Pat. Nos. 3,610,915; 4,337,507; 4,507,717; 4,729,075; 6,170,962; and 4,364,105.

It has also been common with lighting fixtures to provide ballasts that are external to the housings of the lighting fixtures. The primary reason for this has been to protect the ballasts, and temperature-sensitive components contained therein, from the significant or high levels of heat generated in the lighting fixtures. However, by having the ballasts provided exteriorly of the housings of the fixtures this has made these more cumbersome to use and has required the handling of two pieces of equipments whenever such fixtures are used, moved, etc.

### SUMMARY OF THE INVENTION

Accordingly, it is the object of the invention to provide a luminaire which does not exhibit the disadvantages inherent in the prior art lighting fixtures.

It is another object of the invention to provide a luminaire for providing wide-angle illumination on a surface that is simple in construction and economical to manufacture.

It is still another object of the invention to provide a luminaire that provides a substantially even and bright illumination over an extended surface area.

It is yet another object of the invention to provide a luminaire as in the previous object that eliminates the use of a separate, stand-alone ballast.

It is a further object of the invention to provide a luminaire as in the previous object that can be effectively used with CDM metal allied lamps.

It is still a further object of the invention to provide a luminaire of the type under discussion that offers excellent color-rendering, warm-to-cool color appearance.

It is yet a further object of the invention to provide a luminaire as in the previous object that provides extended lamp life with reduced heat and lower energy costs.

It is an additional object of the invention to provide a reflector for use in the luminaire that provides an even and uniform light distribution ideal for use in department stores, display windows, museums, art galleries and other architectural-wise applications.

It is still an additional object of the invention to provide a luminaire that is suitable for blue-screen and chromakey lighting applications in TV and video settings.

In order to achieve the above objects, as well as others which will become evident hereinafter, a luminaire for providing a wide-angle illumination on a surface comprises a housing having an open side. An arcuate reflector having a reflecting surface defining a plane of substantial symmetry is provided, said reflecting surface being mounted within said housing and arranged to orient said reflecting surface in the direction of said open side. Said reflector comprises first and second reflector portions that are substantially mirror image of each other in relation to said plane of symmetry. Said reflecting portions define a focal axis normal to said plane of symmetry and formed of a plurality of substantially elongate reflecting facet surfaces or a series of reflector strips, each of which is substantially parallel to said focal axis. Said arcuate reflector has asymmetrical cross sections in planes substantially normal to said focal axis. Said reflector portions form an indentation or cusp in the direction of said light source at the point where said reflector portions meet along said plane of symmetry at least in the region of said focal axis. A light is mounted generally centrally along said focal axis, to provide both a direct light output and reflected light output through said open side to form a substantially uniform beam along a predetermined distance in a direction substantially parallel to said plane of symmetry.

The invention is also directed to the reflector, formed from an arcuate sheet of reflective material and having the aforementioned configurations and properties.

Another aspect of the invention is the provision of a luminaire that includes a ballast powering the light source receivable in a region within the luminaire housing on a side of the arcuate reflector opposite from the reflecting surface and the open side of the housing. Thermal conduction members are provided between the arcuate reflector and the ballast receiving region for intercepting and conducting heat generated by the reflector and the light source to the thermally conductive housing, diverting much of the heat away from the ballast-receiving region and the ballast.

### BRIEF DESCRIPTION OF THE DRAWINGS

The above and other objects of the invention may be more readily seen when viewed in conjunction with the accompanying drawings, wherein:

FIG. 1 is a prospective view of a luminaire in the form of a “cyc light” in accordance with the present convention;

FIG. 2 is a front elevational view of the cyc light shown in FIG. 1 with a portion thereof removed to show the manner in which the lamp is mounted within the fixture;

FIG. 3 is a cross-sectional view taken along line 3-3 in FIG. 2, with the lamp removed;

FIG. 4 is a view along direction 4 shown in FIG. 5 of the reflector shown in accordance with the present convention;

FIG. 5 is a cross-sectional view of the reflector shown in FIG. 4, taken along line 5-5;

FIG. 6 is a rear elevation view of the reflector shown in FIGS. 4 and 5;

FIG. 7 is a top-plan view of the reflector shown in FIG. 5;

FIG. 8 is a ray diagram illustrating the distribution of the illumination intensity along a surface spaced a predetermined distance from the fixture;

FIG. 9 is a diagrammatic view of a CDM metal halide lamp or bulb of the type contemplated to be used with the luminaire in accordance with the present convention; and

FIG. 10 consists of a set of Isolux curves on a projection screen, illustrating the optical behavior of the luminaire.

### DESCRIPTION OF THE PREFERRED EMBODIMENTS

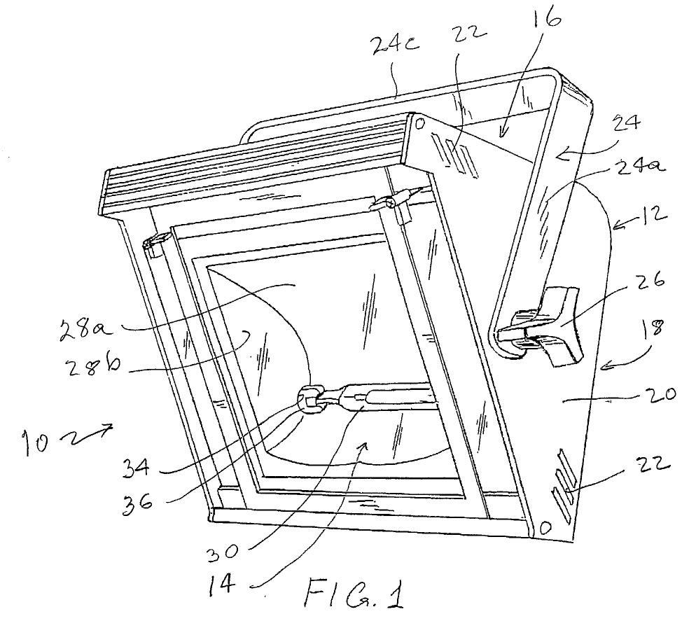

Referring now more specifically to the figures, in which identical and similar parts designated by the same reference numerals throughout, and first referring to FIG. 1, a luminaire for providing wide-angle illumination surface in accordance with the present invention is generally designated by the reference numeral 10.

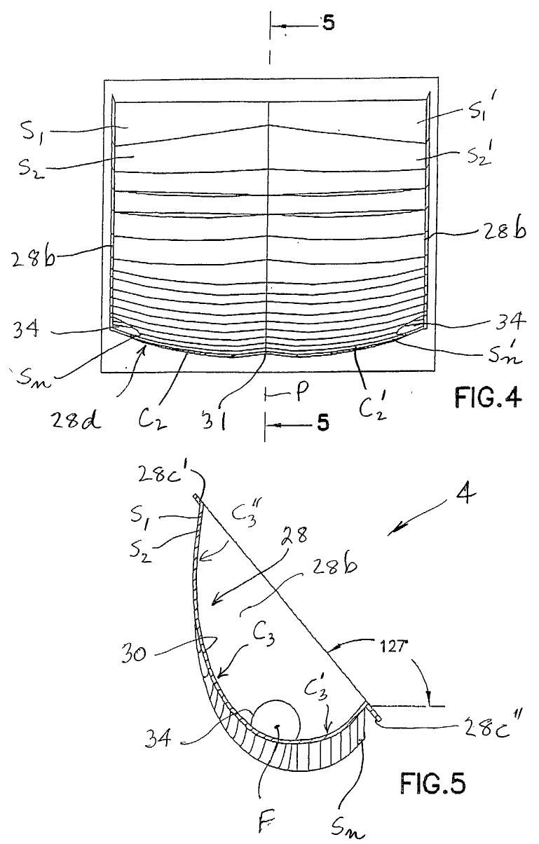

The luminaire 10 includes a housing 12 having an open side 14. While the specific configurations of the housing 12 is not critical, the housing is shown to be substantially enclosed with the exception of the open side 14, being otherwise enclosed by shorter longitudinal sides 16, 18 and transverse lateral sides 20 at each end or side of the housing. The walls or lateral sides 20 are preferably provided with venting slots 22, for reasons that will be more fully discussed below. A conventional C-shaped yoke 24 is pivotably connected to the side-walls 20 of the housing by means of a bolt (not shown) and knob 26. The yoke 24 includes two lateral arms 24a, 24b and a transverse section 24c that may be adapted to be conventionally secured to a surface, such as a ceiling (when the luminaire 10 is oriented as shown in FIG. 1.) A arcuate reflector 28 is mounted within the housing 12 and arranged to orient a reflecting surface 28a in the direction of the open-side 14. As to be more specifically described, the arcuate reflector 28 defines a plane of substantial symmetry P (FIGS. 4, 6, and 7), the reflector defining a focal axis F (FIGS. 1, 3, and 5). A light source 30, in the form of an elongate bulb 30, is mounted generally centrally along the focal axis F. It will be evident that such lamp or bulb 30 will provide both a direct light output and a reflected light output through the open side 14. A feature of the invention is to use these two light components to form a substantially uniform composite beam along a predetermined distance in a direction substantially parallel to the plane of symmetry.

Referring to FIGS. 4-7, the reflector is shown to include an integrally formed a side or lateral wall 28b, a peripheral lip, flange or ledge 28c (FIG. 4) formed in a common plane, and first and second reflector portions 28d and 28e that are substantially mirror images of each other in relation to the plane of symmetry P.

Each reflector portion 28d, 28e defines or forms substantially elongate reflecting facet surfaces or reflector strips s₁, s₂, s₃, . . . sₙ on the reflector portion 28d and corresponding facets or strips s₁′, s₂′ . . . sₙ′ on the reflector portion 28e. The facets or strips are substantially parallel to the focal axis F. Like the first and second reflector portions 28d, 28b, which are substantially mirror images of each other in relation to the plaintiff's symmetry P, the facets or surfaces are likewise mirror images about the plane P.

As best shown in FIG. 5, the arcuate reflector 28 has an asymmetrical cross-section in planes that are substantially normal to the focal axis F. The reflector portions 28d, 28e form an indentation or cusp 31 in the direction of the focal axis F and, therefore, the light source in the form of bulbor lamp 30, the indentation or cusp generally coinciding with the point where the reflector portions 28d, 28e meet along the plane of symmetry P, at least in the region of or surrounding the focal axis P. In FIG. 5, the degree of indentation is best illustrated, where it is indicated that the indentation is greatest in the region of the focal axis F and gradually decreases in the direction of the upper ledge 28c′, as viewed in FIG. 5.

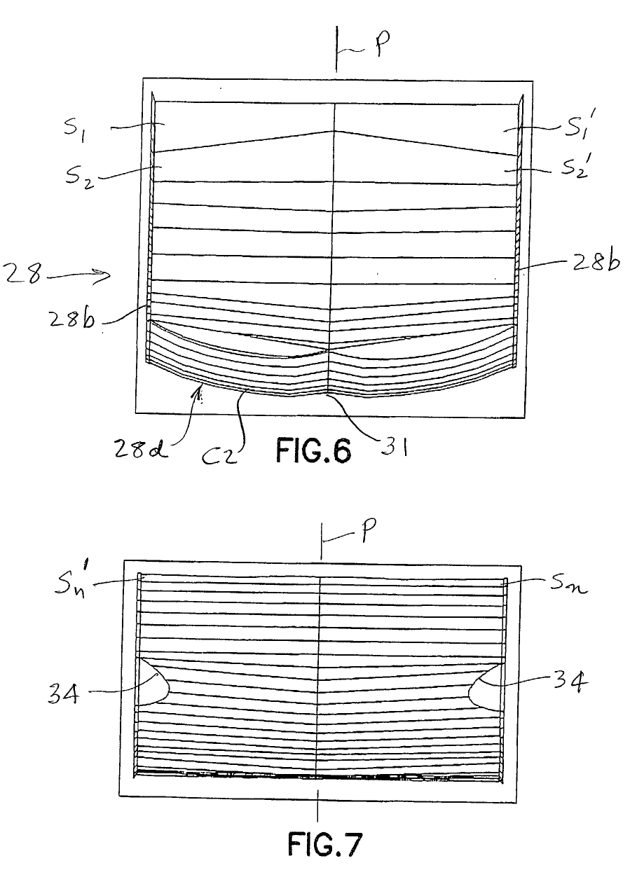

Although the elongate reflecting facet surfaces or reflector strips may be substantially uniform in width, between the lateral walls 28b and the plane of symmetry P it will be noted, particularly in FIGS. 4 and 6, that the strips may take on different configurations and may be, for example, tapered or converge at points along the plane of symmetry P or diverge at such plane, as in the case of strips s₂, s₂′ as shown in FIG. 4. The shapes of the strips shown in FIGS. 4, 6 and 7 more closely represent idealized or theoretical shapes in order to maximize the illumination intensity for a given lamp or bulb 30, e.g., metal halide lamps. Examples of such lamps includes GE lamp Q650T3/4, 650 Watts bulb. Generally, the reflector shown can be used with a wide variety of elongate lamps. However, to the extent that the filaments of such lamps are different sizes the specific shapes and configurations of the facets or strips may be modified to enhance or optimize the desired results. In practice, it may be difficult to achieve the idealized forms shown when the reflector is produced in accordance with certain manufacturing methods. If the reflector, for example, is machined from a block of materials it may be possible to achieve the precise facets desired. However, such machined reflectors would be more expensive to produce and might not be commercially viable. It has been found that reflectors of the type shown in FIGS. 4-7 can be produced from a thin sheet of flexible reflective materials, such as aluminum, by hydroform molding. Such process entails placing a flat sheet of reflective materials, such as aluminum, on a suitably shaped die and applying pressure from an opposing direction by means of a liquid-filled deformable boot that applies substantially uniform pressure on the sheet of aluminum as it is pressed against the die. Such a process tends to soften or round-out what would otherwise be sharp edges. With such a process, the more detailed features, including very close or small facets that converge at points tend to be subdued or even eliminated. It has been found, however, that such reflectors nevertheless produce satisfactory results and are sufficiently close or accurate to the ideal or theoretical form that there is not too much deterioration in the optical performance of properties of the reflector.

Referring to FIGS. 4 and 6, it will be noted that the indentation or cusp 30 results in a substantially symmetrical reflector configurations on either side of the plane of symmetry P, generating curve C₂, C₂′ generally defined by polynomials, the simplest of which are represented by parabolic, ellipsoidal and other low order functions. However, the polynomials represented by the curve C₂, C₂′ can be much more complex curves and these may be desirable in order to optimize reflecting performance for any given lamps or bulbs used in the light fixture. Similarly, an important feature of the present invention is that the arcuate reflector 28 has an asymmetrical cross-section in planes substantially normal to the focal axis F, as best shown in FIG. 5. The specific asymmetrical cross-section used is not critical, and the curve C₃ can be defined by a single function or may represent a composite of two or more functions along different portions of the reflector. In FIG. 5, for example, the curve C₃ is shown to be formed of a first portion C₃′, in the proximity of the focal axis F, and a curved portion C₃″, which represent that portion of the reflector more remote from the focal axis F. As indicated, the specific mathematical functions representing these curves are not critical as long as the overall curve is asymmetrical in relationship to the focal axis F. It has been found, for example, that the curve C₃ may be defined by any one of a number of different transcendental curves. Thus, for example, the curve C₃ may be any one of a number of mathematically defined spirals, or clearly a portion thereof, including a linear spiral, a parabolic spiral, or a logarithmic spiral. Where desired, the curved portion C₃″ may be a curve that approaches a substantially flat plane that asymptotically approaches a desired direction. The overall configurations or composite configurations of the curve C₃ will at least partially be a function of the uniformity and size of the illumination desired to be projected by the fixture. In this connection, as suggested, it may be noted that other asymmetric curves might be suitable for certain applications. It may also be possible, for example, to use a portion of a cycloid or other generally symmetrical curve. A selected portion of a symmetrical curve might be suitable if it results in an asymmetrical portion of the curve being used. Therefore, it will be clear that the curve C₃ can represent one more functions that generate an asymmetrical shape or a portion of a symmetrical shape can be used that, when properly placed, results in an asymmetrical reflector.

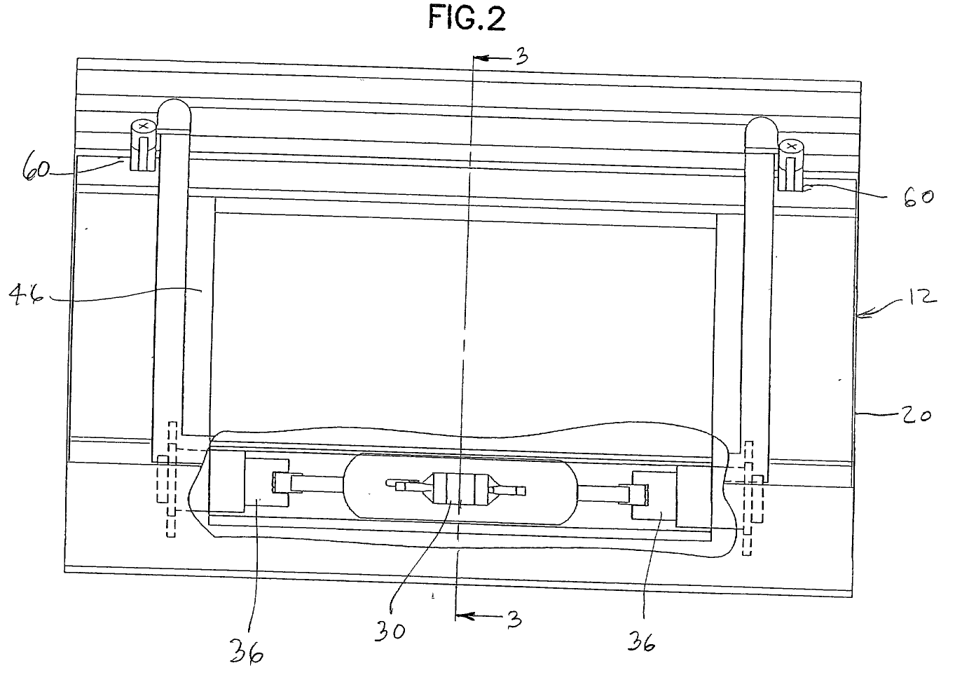

Referring to FIGS. 1, 3 and 5, for example, the side walls 28b of the reflector 28 are provided with holes or openings 34, such cutouts or holes being provided on both opposing sidewalls of the reflectors and generally aligned along the focal axis F. Suitable sockets 36 are provided that extend through the openings 34 and are arranged to receive the ends of the bulb or lamp 30. FIG. 2 illustrates the general position and method of mounting the bulb 30 within the unit.

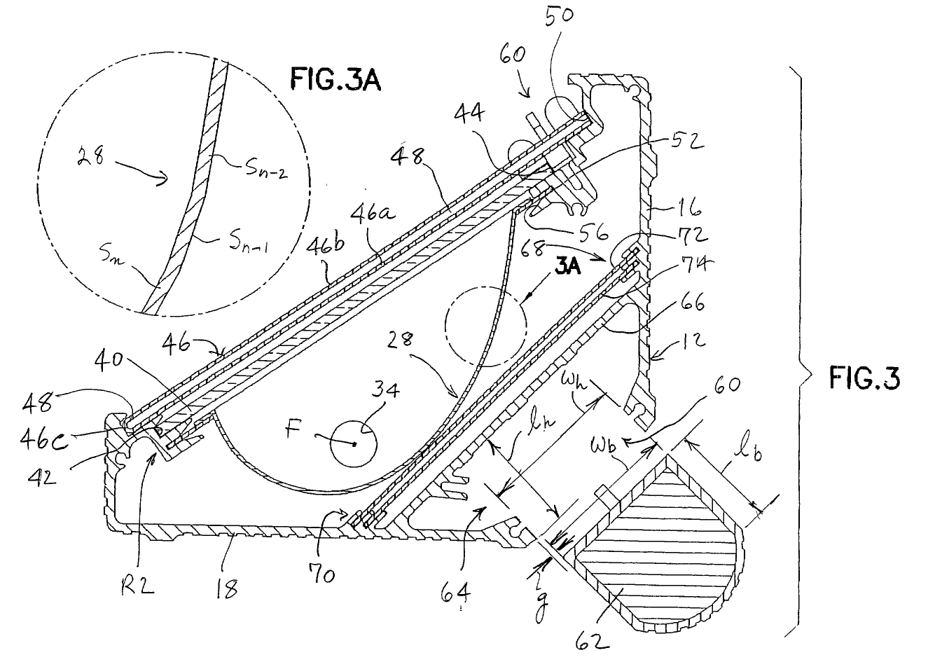

Referring more specifically to FIG. 3, the housing 12, with the exception of the side or lateral walls 20, may be formed of an extruded conductive material such as aluminum. The extrusion is generally designated by the reference 38 then includes the short walls 16, 18 referred to in connection with FIG. 1 the open along the side 14 is covered by a transparent protective footing in the form of a sheet of tempered glass that shields the lamp or bulb 30, the reflector 38 and serves as a safety shield to protect people handling the unit. The transparent plate or cover 40 may be suitably mounted within a recess 42 and against a support surface 44 formed in the extrusion 38. Advantageously, and out of frame 46m, received within groove 48 and a support surface 50, also formed in the extrusion. Similarly, the first and second retainers R1, R2 include suitable means for securing the upper and lower ledges or flanges 28c′, 28c″. In FIG. 3 such reflector securing structure includes slotd 52, 54 suitably paced from each other and preferably provided with tapers or leadens 56 to facilitate the insertion of the upper and lower ledges or flanges into the receiving slots 52, 54. The reflector can, thus, be mounted within the housing by temporarily deforming the reflector and moving the ledges 28c′, 28c″ closer together to allow these to be inserted within the associated slots 52, 54.

The arcuate frame 46 consists of may be conventionally frame for mounting additional light, light-altering materials such as color filters. Thus, the frame 46 can include an inner frame 46a and an arcuate frame 46b pivotably mounted at a hinge or plastic joint 46c. East of the in and out of frame each consists of essentially rectangular frame having a rectangular opening therein and forming, one of the cross positions, an intermediate space 48 into which the light-altering or modifying material is placed.

Once placed within the groove 48 and supported by surface 50, the frame 46 maybe retained within the fixture by means of [locking] tapes 60, that are pivotably mounted so that they can be moved between locking and releasing positions.

According to one feature of the invention, the housing 12 is provided with an opening 60 dimensioned to receive a ballast 62 within a interior region or space 64, generally behind the reflector 28. In order to prevent excessive heat from flowing to the space 64 and the ballast 62 there is advantageously provided an interior partition 66 that separates the space 64 from the space to the other side of the partition in which the lamp and reflector are mounted. This prevents direct radiation from impinging on the ballast 62. In this connection, there may also be provided additional retainers 68, 70, joining 63, for supporting one or more heat shields 72, 74. Because the ballast includes components that are temperature sensitive, the partition 66 and heat shields 72, 74 are intended to deflect some of the heat generated by the bulb and to reduce the temperature of the ballast as much as is practicable. Venting slot 22, as aforementioned, may also be provided in the side or lateral walls 20 to allow the heat to escape.

In FIG. 3, the dimensions 1ₕ and wₕ are selected to allow the ballast to be received with some clearance. Thus, the dimensions, wₕ is preferably somewhat larger than the width of the ballast w_{b} so as to provide an air-gap g which serves to act as a thermal break and to minimize the amount of heat conducted through the housing 12 to the ballast 62. For this reason, as well, the dimension 1ₕ should be somewhat greater than dimension 1_{b} of the ballast so that there is no direct contact between the ballast and the interior partition 66. The objective in selecting the dimensions and a number and extent of the use of heat shield is to provide a safety margin in the temperatures that the ballast is exposed to. It has been found that the use of the heat shields 72, 74, together with the interior partition 66, can reduce the temperature of the ballast by at least 5° or more, and to maintain the ballast at least 5° at the cutoff temperature for the ballast. Since typical ballast cutoffs at 85° C., the temperature of the ballast should be maintained at a temperature no greater than 80° C.

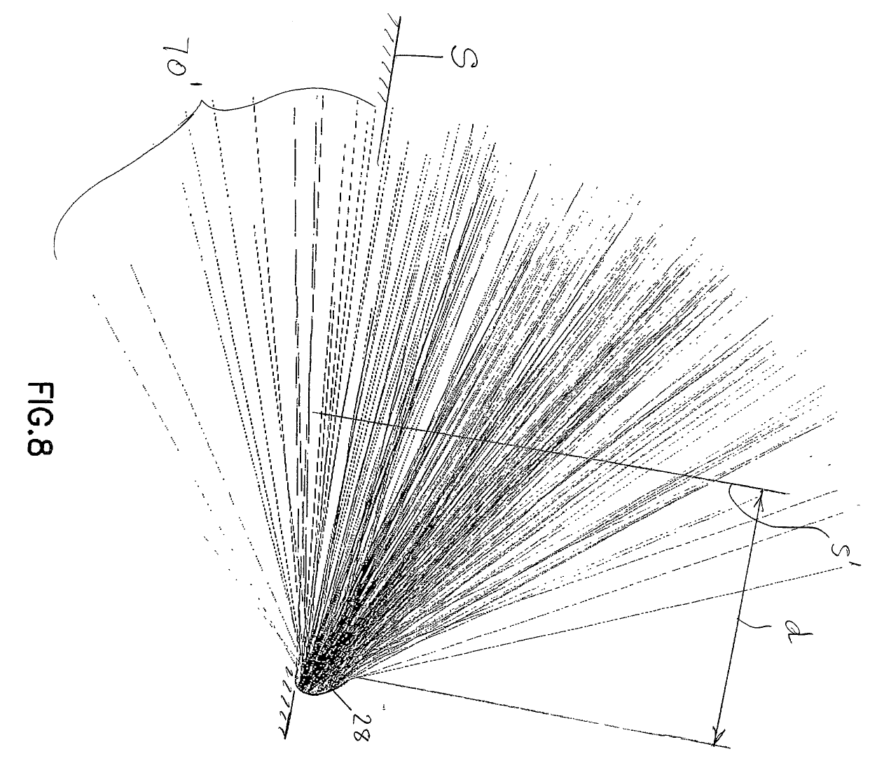

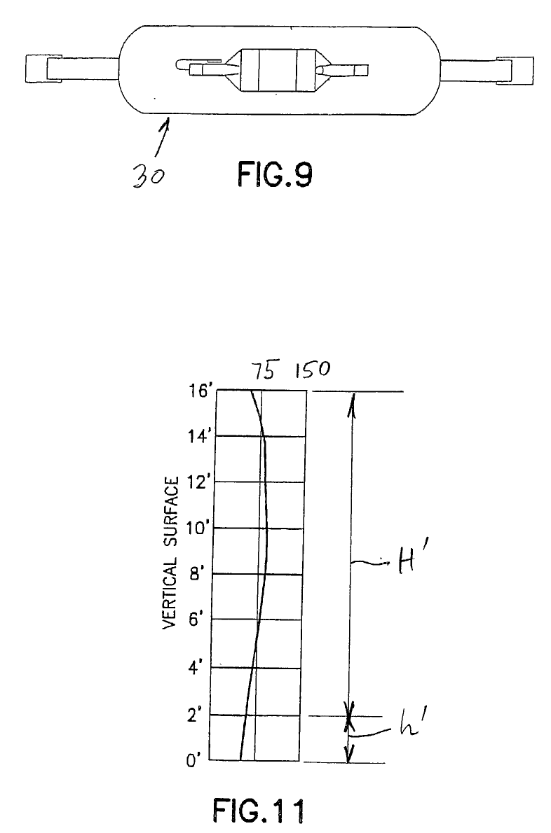

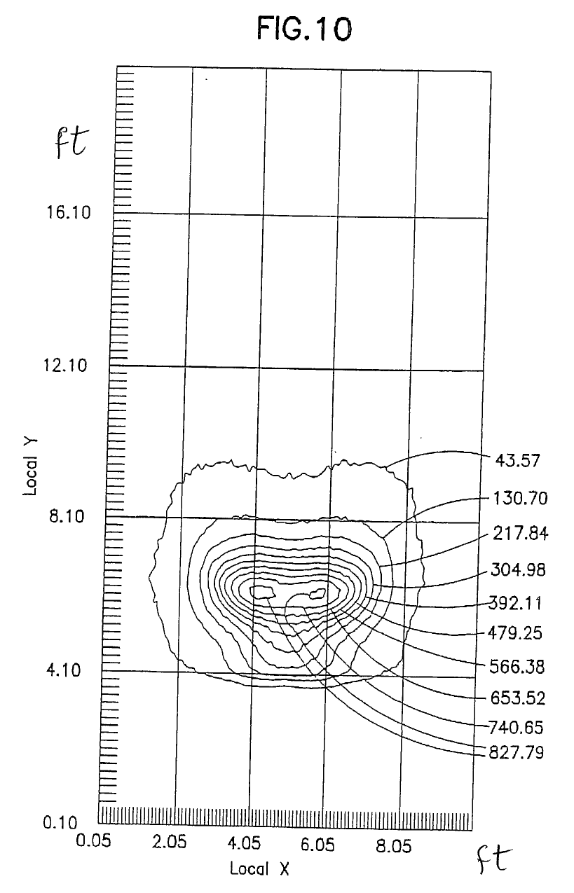

In FIG. 8, a ray diagram is always treaded, diagrammatically depicting the rays of light emanating from a reflector 28 in accordance with the present convention resting on a surface S. Whether the surface S is the floor on which the fixture rests, whether it is the ceiling (in which case the reflector would be reversed), the rays in region 70 typically cutoff by the fixture itself or impinged on the surface S. However, for rays emanating beyond the region 70 these project a surface S′ over a predetermined height h when the surface is spaced from the lamp or fixture a distance d from the fixture. FIGS. 10 and 11 illustrate the light intensity distributions with the exception of the first 2 feet of vertical surface (height h′) the distribution over the remaining height 2″-16″ over the height H′ the distribution is relatively flat and uniformed. The chart illustrated in FIG. 11 is obtained by utilizing CDM 150/TD/T6 lamps the distance of the surface in which the light is illuminated being 4″ from the light fixture and the intensity of illumination varies or fluctuate very close to the 75 foot candles intensity over the height H′.

It should be clear, therefore, that the light fixture with a reflector of the type described is a good choice for applications requiring a bright even wash of light extending over a large area. The luminaire offers excellent color-rendering, warm to cool color appearance and extended lamp life with reduced heat and low energy costs. Because the reflector provides an even and uniform light distribution it is a ideal for use in the department stores, display windows, museums, art galleries, and other architectural wash applications. It is also very well-suited for use with blue screen and chromokey lighting applications in TV and video settings.

While this invention has been described in detail with particular reference to preferred embodiments thereof, it will be understood that variations and modifications will be effected within the spirit and scope of the invention as described herein and as defined in the appended claims.

What I/we claim:

1. A luminaire for providing wide-angle illumination on a surface, comprising:
(a) a housing having an open side;
(b) an arcuate reflector having a reflecting surface defining a plane of substantial symmetry, said reflecting surface being mounted within said housing and arranged to orient said reflecting surface in the direction of said open side, said reflector comprising first and second reflector portions that are substantially mirror images of each other in relation to said plane of symmetry, said reflecting portions defining a focal axis normal to said plane of symmetry and formed of a plurality of a substantially elongate reflecting facet surfaces or a series of reflector strips each of which is substantially parallel to said focal axis, said arcuate reflector having non-symmetrical cycloidal cross-sections in planes substantially normal to said focal axis, said reflector portions forming an indentation or cusp in the direction of said light source at the point where said reflector portions meet along said plane of symmetry at least in the region of said focal axis; and
(c) a light source mounted centrally along said focal axis, to provide both a direct light output and a reflected light output through said open side to form a substantially uniform beam along a predetermined distance in a direction substantially parallel to said plane of symmetry.

2. A luminaire as defined in claim 1, wherein said housing has a plane of substantial symmetry coextensive with said plane of symmetry of said reflector.

3. A luminaire as defined in claim 1, wherein said housing has a plane of substantial symmetry.

4. A luminaire as defined in claim 1, wherein said non-symmetrical cross-sections of said arcuate reflector define a section of a transcendental curve.

5. A luminaire as defined in claim 4, where said transcendental curve is a spiral.

6. A luminaire as defined in claim 5, where said transcendental curve is a linear spiral.

7. A luminaire as defined in claim 5, where said transcendental curve is a parabolic spiral.

8. A luminaire as defined in claim 5, where said transcendental curve is a logarithmic spiral.

9. A luminaire as defined in claim 1, wherein said non-symmetrical cross-section of said arcuate reflector defines a section of a cycloid.

10. A luminaire as defined in claim 1, wherein said facet surface or reflector strips have widths that generally increase with increasing distances from said focal axis.

11. A reflector for a luminaire for providing wide-angle illumination on a surface, comprising an arcuate sheet of material having a reflecting surface defining a plane of substantial symmetry, said reflecting surface being mounted with said housing and arranged to orient said reflecting surface in the direction of said open side, said reflector comprising first and second reflector portions that are substantially mirror images of each other in relation to said plane of symmetry, said reflecting portions defining a focal axis normal to said plane of symmetry and formed of a plurality of a substantially elongate reflecting facet surfaces or a series of reflector strips each of which is substantially parallel to said focal axis, and arcuate reflector having non-symmetrical cross-sections in planes substantially normal to said focal axis, said reflecting portions forming an indentation or cusp in the direction of said light source at the point where said reflector portions meet along said plane of symmetry at least in the region of said focal axis.

12. A luminaire as defined in claim 11, wherein said non-symmetrical cross-sections of said arcuate reflector define a section of a transcendental curve.

13. A luminaire as defined in claim 12, where said transcendental curve is a spiral.

14. A luminaire as defined in claim 12, where said transcendental curve is a linear spiral.

15. A luminaire as defined in claim 12, where said transcendental curve is a parabolic spiral.

16. A luminaire as defined in claim 12, where said transcendental curve is a logarithmic spiral.

17. A luminaire as defined in claim 11, wherein said non-symmetrical cross-section of said arcuate reflector defines a section of a cycloid.

18. A luminaire as defined in claim 11, wherein said facet surface or reflector strips have widths that generally increase with increasing distances from said focal axis.

19. A luminaire for providing wide-angle illumination on a surface, comprising:
(a) a housing having an open side and made of a thermally conductive material;
(b) an arcuate reflector having a reflecting surface, said reflecting surface being mounted within said housing and arranged to orient said reflecting surface in the direction of the open side, said reflector defining focal axis, said arcuate reflector having non-symmetrical cross-sections in planes substantially normal to said focal axis;
(c) a light source mounted centrally along said focal axis, to provide both a direct light output and a reflected light output through said open side to form a substantially uniform beam along a predetermined distance in a direction substantially parallel to said plane of symmetry;
(d) a ballast for powering said light source receivable with a region within said housing on a side of said arcuate reflector directed away from said reflecting surface; and
(e) thermal conduction means between said arcuate reflector and said ballast-receiving region for conducting heat for said reflector due to said light source to said thermally conductive housing.

20. A luminaire as defined in claim 19, further comprising thermally insulating means for least partially thermally insulating said ballast from the flow of heat from said housing to said ballast.

21. A luminaire as defined in claim 20, wherein said thermally insulating means comprises an air gap at least partially surrounding said ballast, with said housing to reduce the area of physical and thermal contact with said housing.
